(19) United States
(12) Patent Application Publication
(10) Pub. No.: US 2019/0265854 A1
(43) Pub. Date: Aug. 29, 2019

(54) HEAD-MOUNTED DISPLAY APPARATUS AND METHOD FOR CONTROLLING HEAD-MOUNTED DISPLAY APPARATUS

(71) Applicant: SEIKO EPSON CORPORATION, Tokyo (JP)

(72) Inventors: Fumiya HORI, Ueda-shi (JP); Chiho TACHIKAWA, Ueda-shi (JP)

(73) Assignee: SEIKO EPSON CORPORATION, Tokyo (JP)

(21) Appl. No.: 16/283,095

(22) Filed: Feb. 22, 2019

(30) Foreign Application Priority Data
Feb. 23, 2018 (JP) 2018-030857

(51) Int. Cl. G06F 3/0484; G06F 3/16; G06F 3/01; G06F 17/24; G06F 21/60; G02B 27/01

(52) U.S. Cl. CPC G06F 3/0484; G06F 3/167; G06F 3/017; G06F 3/012; G02B 2027/014; G06F 21/60; G02B 27/0172; G02B 2027/0178; G02B 2027/0138; G06F 17/24

(57) ABSTRACT

Provided are a display unit, a first input portion configured to receive an input, a second input portion configured to receive an input performed in a different manner from the input to the first input portion, a controller configured to perform an input mode in which a user interface for character input is displayed and then a character or a character string is allowed to be entered, wherein the controller is configured to cause auxiliary data to be displayed in response to the input received at the first input portion, and to then cause the auxiliary data to be edited in response to the input received at the second input portion to cause the edited data to be input to the user interface.

### BACKGROUND

### 1. Technical Field

The invention relates to a head-mounted display apparatus and a method for controlling the head-mounted display apparatus.

### 2. Related Art

Regarding entering a character or a character string such as passwords, there have been proposed means for assisting operations of the entering, maintaining the confidentiality of information to be entered as far as possible (see, for example, JP-A-2005-174023). JP-A-2005-174023 discloses a method of displaying a drum-like Graphical User Interface (GUI) in case when allowing a password to be entered on a logon screen, to be entered.

The configuration of JP-A-2005-174023 causes the drum-like GUI to be operated, by which characters are made entered one by one, thus preventing leakage of the password. Unfortunately, this type of method needs a greater burden of operations, with lots of care required, in such a case when the number of characters of the character string that needs to be entered is large.

### SUMMARY

The object of the invention is to maintain the confidentiality of data constituted by a character or a character string when the data is to be entered and to alleviate the burden of an operation of entering the data.

In order to achieve the above-described object, the head-mounted display apparatus of the invention includes a display unit to be mounted on a head of a user, a first input portion configured to receive an input by the user, a second input portion configured to receive an input by the user in a different manner from the input to first input portion, and an input controller configured to perform an input mode in which the display unit is caused to display a user interface for character input and to then cause a character or a character string to be entered, wherein the input controller is configured to cause, in the input mode, auxiliary data to be arranged and to be then displayed on the user interface in response to the input received at the first input portion, and to then cause the auxiliary data to be edited in response to the input received at the second input portion to cause the edited data to be input to the user interface, and wherein the auxiliary data includes a first attribute and a second attribute, the first attribute being common with normal data to be entered in the user interface, and the second attribute being data that is different from the normal data.

According to the invention, in case when a character or a character string is to be entered in the user interface, displaying auxiliary data having an attribute common with and an attribute different from normal data to be entered allows a normal character or a normal character string to be entered by causing the auxiliary data to be edited. This allows the confidentiality of a normal character or a normal character string to be maintained, alleviating the burden of the input operations. This further allows auxiliary data different from a normal character or a normal character string to be displayed on the display unit to be mounted on the head of the user, enabling the confidentiality of the input data to be more reliably maintained.

The invention may also employ a configuration in which the auxiliary data and the normal data are each constituted by a character string, wherein the first attribute is number of characters, and the second attribute is any one character or more of characters.

The above configuration allows, in case when a character or a character string is to be entered, the auxiliary character string having number of characters common with and any one or more characters different from a normal character or a normal character string to be displayed, alleviating the burden of input operations of entering a character or a character string in the user interface.

The invention may also employ a configuration including a storage configured to store the normal data in association with an input received at the first input portion, wherein the input controller is configured to cause the auxiliary data to be generated based on the normal data stored in the storage in association with the input received at the first input portion, and to then cause the auxiliary data to be arranged and to be then displayed on the user interface.

The above configuration allows auxiliary data to be displayed on the user interface corresponding to a normal character or a normal character string to be generated, eliminating the need of storing auxiliary data beforehand, to thus cause the processing to be performed in an efficient manner.

The invention may also employ a configuration including a storage configured to store the normal data, the auxiliary data, and the input received at the first input portion in association with one another, wherein the input controller is configured to cause the auxiliary data stored in the storage in association with the input received at the first input portion to be arranged and to be then displayed on the user interface.

The above configuration allows the auxiliary data displayed on the user interface to be stored in association with the operations of the user, enabling appropriate auxiliary data corresponding to the operations of the user to be displayed. The above configuration further allows the user to readily recognize the auxiliary data displayed in association with the operation, alleviating the burden of an operation of editing the auxiliary data in an efficient manner.

The invention may also employ a configuration in which the user interface includes a plurality of input areas where data input is required, and the controller is configured to causes the auxiliary data to be arranged and to be then displayed in any one of the input areas.

The above configuration allows, by a method of causing auxiliary data to be edited, a character or a character string to be readily input to a part of an input area arranged in the user interface.

The invention may also employ a configuration in which the input controller is configured to cause, in case when causing the auxiliary data to be edited in response to the input received at the second input portion and then receiving an input at the first input portion or the second input portion, the edited data to be input.

The above configuration allows the operator to instruct whether to confirm the data edited from the auxiliary data, to thus prevent an erroneous input from being performed.

The invention may also employ a configuration including a third input portion, wherein the controller is configured to cause, in case when causing the auxiliary data to be edited in response to the input received at the second portion and then receiving an input at the third input portion, the edited data to be input.

The above configuration allows the operator to instruct whether to confirm the data edited from the auxiliary data with an operation different from the operations detected by the first input portion and the second input portion, to thus prevent an erroneous input from being performed.

The invention may also employ a configuration in which the first input portion or the second input portion is configured to detect a sound input.

The above configuration allows operations related to displaying auxiliary data or editing auxiliary data to be performed by way of voice, alleviating the burden of an operation related to the input operation of a character or a character string in more efficient manner.

The invention may also employ a configuration including an image capturing unit, wherein the first input portion or the second input portion is configured to detect an input of at least one of a position and a motion of an indicator from an image captured by the image capturing unit.

The above configuration allows operations related to displaying auxiliary data or editing auxiliary data to be performed by using the position and/or motion of the indicator, alleviating the burden of an operation related to the input operation of a character or a character string in more efficient manner.

The invention may also employ a configuration including an image capturing unit, wherein the first input portion or the second input portion is configured to detect a code imaged from an image captured by the image capturing unit.

The above configuration allows operations related to displaying auxiliary data or editing auxiliary data to be performed by causing the image of the imaged code to be captured, alleviating the burden of an operation related to the input operation of a character or a character string in more efficient manner.

The invention may also employ a configuration including an image capturing unit, wherein the first input portion or the second input portion is configured to detect, as an input, an image of a subject included in an image captured by the image capturing unit.

The above configuration allows operations related to displaying auxiliary data or editing auxiliary data to be performed by causing an image of the subject to be captured, alleviating the burden of an operation related to the input operation of a character or a character string in more efficient manner.

In order to achieve the above-described object, the invention is a method for controlling a head-mounted display apparatus including a display unit to be mounted on a head of a user, the method being capable of performing an input mode in which the display unit causes a user interface for character input to be displayed to cause a character or a character string to be entered in the user interface, the method including causing a first input by the user and a second input in a different manner from the first input to be received, and including, in the input mode, displaying auxiliary data having a first attribute and a second attribute, the first attribute being common with normal data to be entered in the user interface and the second attribute being different from the normal data, on the user interface in response to the first input, and causing the auxiliary data to be edited in response to the second input to cause the edited data to be input to the user interface.

According to the invention, in case when a character string is to be entered in the user interface, displaying auxiliary data having an attribute common with and an attribute different from normal data to be entered allows normal data to be entered by causing the auxiliary data to be edited. This allows the confidentiality of normal data to be maintained, facilitating the operations of entering normal data. This further allows auxiliary data different from a normal character or a normal character string to be displayed on the display unit to be mounted on the head of the user, enabling the confidentiality of the input data to be more reliably maintained.

### BRIEF DESCRIPTION OF THE DRAWINGS

The invention will be described with reference to the accompanying drawings, wherein like numbers reference like elements.

FIG. 1 is an explanatory view illustrating an external configuration of an HMD.

FIG. 2 is a block diagram illustrating a configuration of an HMD.

FIG. 3 is a functional block diagram of a controller.

FIG. 4 is a schematic diagram illustrating a configuration example of input auxiliary data.

FIG. 5 is a flowchart illustrating operations of an HMD.

FIG. 6 is a diagram illustrating a configuration example of a screen displayed by an HMD.

FIG. 7 is a diagram illustrating a configuration example of a screen displayed by an HMD.

FIG. 8 is a diagram illustrating a configuration example of a screen displayed by an HMD.

FIG. 9 is a diagram illustrating a configuration example of a screen displayed by an HMD.

FIG. 10 is a diagram illustrating a configuration example of a screen displayed by an HMD.

FIG. 11 is a diagram illustrating a configuration example of a screen displayed by an HMD.

### DESCRIPTION OF EXEMPLARY EMBODIMENTS

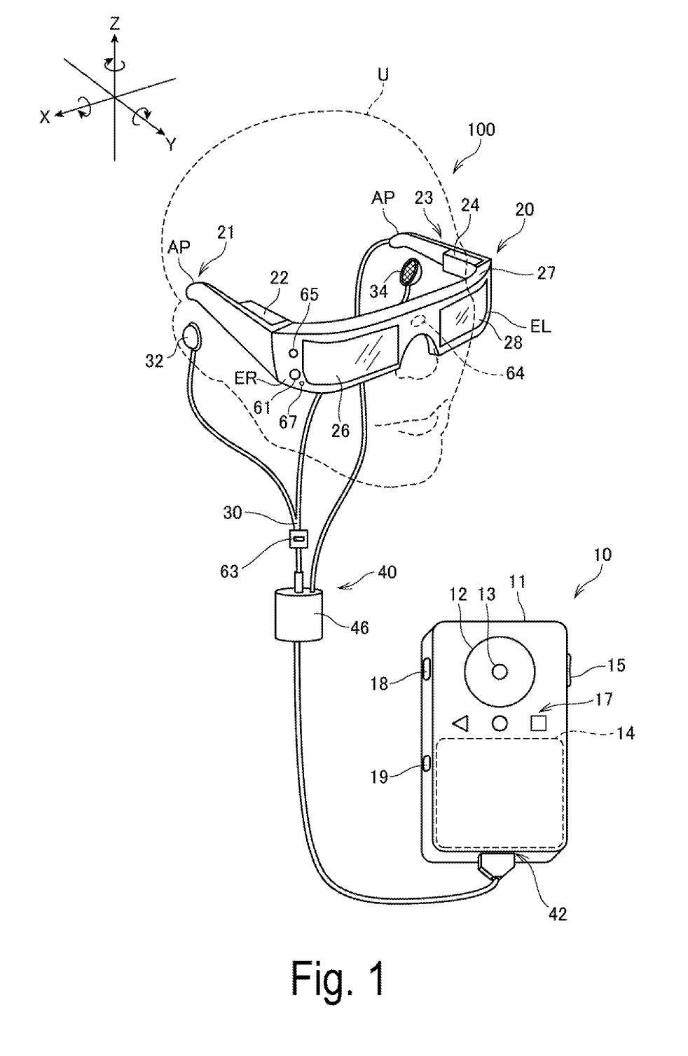

Exemplary Embodiments of the invention will now be described herein with reference to the accompanying drawings. FIG. 1 is a view illustrating an external configuration of a Head-Mounted Display (HMD) 100.

The HMD 100 includes an image display unit 20 and a controller 10 as a controller configured to control the image display unit 20.

The image display unit 20 having a spectacle shape in the exemplary embodiment, is mounted on the head of a user U. The image display unit 20 allows the user U to view a virtual image in a state of wearing the HMD 100. The function of the image display unit 20 causing the virtual image to be visually recognized can be referred to as being “display”, where the image display unit 20 corresponds to the “display unit” of the invention.

The controller 10 is configured to include, on a main body 11 in a box-shape, operation components each configured to receive an operation of the user U as described below, where the controller 10 is also configured to function as a device configured to allow the user U to operate the HMD 100.

The image display unit 20 includes a right holding part 21, a left holding part 23, a front frame 27, a right display unit 22, a left display unit 24, a right light-guiding plate 26, and a left light-guiding plate 28. The right holding part 21 and the left holding part 23 extending rearward from the both end portions of the front frame 27 cause the image display unit 20 to be held on the head of the user U. The end portion located, among the both end portions of the front frame 27, at the right side of the user U when the image display unit 20 is being worn is defined as an end portion ER, while the end portion located at the left side as an end portion EL.

The right light-guiding plate 26 and the left light-guiding plate 28 are fixed to the front frame 27. In the state of wearing the image display unit 20, the right light-guiding plate 26 is located before the right eye of the user U, while the left light-guiding plate 28 is located before the left eye of the user U.

The right display unit 22 and the left display unit 24 are modules respectively formed into units with optical units and peripheral circuits and are each configured to emit imaging light. The right display unit 22 is attached to the right holding part 21, while the left display unit 24 is attached to the left holding part 23.

The right light-guiding plate 26 and the left light-guiding plate 28, which are optical parts made of resin or the like transmissive of light, are formed of, for example, prisms. The right light-guiding plate 26 guides the imaging light output from the right display unit 22 to the right eye of the user U, while the left light-guiding plate 28 guides the imaging light output from the left display unit 24 to the left eye of the user U. This allows the imaging light to be incident on the both eyes of the user U, causing the user U to visually recognize the image.

The HMD 100 is a see-through type display device, and imaging light guided by the right light-guiding plate 26 and external light transmitted through the right light-guiding plate 26 are incident on the right eye of the user U. Similarly, imaging light guided by the left light-guiding plate 28 and external light transmitted through the left light-guiding plate 28 are incident on the left eye of the user U. In this way, the HMD 100 superimposes the imaging lights corresponding to the internally processed images and the external lights and causes the superimposed lights to be incident on the eyes of the user U. This allows the user U to see an outside view through the right light-guiding plate 26 and the left light-guiding plate 28, enabling the image due to the imaging light to be visually recognized in a manner overlapped with the outside view.

An illuminance sensor 65 is arranged on the front frame 27 of the image display unit 20. The illuminance sensor 65 receives external light entering from the front of the user U wearing the image display unit 20.

A camera 61 (image capturing unit) is arranged on the front frame 27 at a position where no external lights transmitted through the right light-guiding plate 26 and the left light-guiding plate 28 are blocked. In the example of FIG. 1, the camera 61 is arranged on the end portion ER side of the front frame 27. The camera may also be arranged on the end portion EL side, or may also be arranged at the coupling portion between the right light-guiding plate 26 and the left light-guiding plate 28.

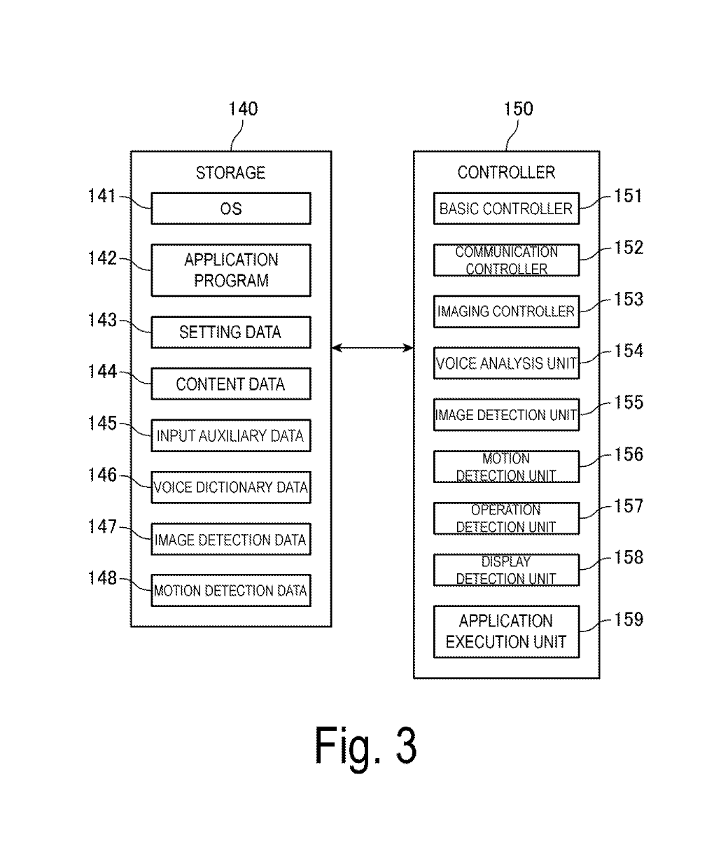

The camera 61 is a digital camera including an image capturing device, an image capturing lens, and the like, and may be a monocular camera or a stereo camera. The image capturing device of the camera 61 can be, for example, a Charge Coupled Device (CCD) image sensor, or a Complementary MOS (CMOS) image sensor. The camera 61 executes imaging in accordance with the control of a controller 150 (FIG. 3), and outputs the captured image data to the controller 150.

In a state where the user U is wearing the image display unit 20, the camera 61 faces the front direction of the user U. Accordingly, in the state of wearing the image display unit 20, the image capturing range (or the angle of view) of the camera 61 includes at least a part of the field of view of the user U, and more specifically, the image capturing range includes at least a part of the outside view, seen by the user U, transmitted through the image display unit 20. Furthermore, the entire field of view visually recognized by the user U, which is transmitted through the image display unit 20, may be included in the angle of view of the camera 61.

The front frame 27 is arranged with a light emitting diode (LED) indicator 67. The LED indicator 67 lights up during the operation of the camera 61, indicating that the camera 61 is being in the operation of capturing images.

The front frame 27 is provided with a distance sensor 64. The distance sensor 64 is configured to detect a distance to an object to be measured lying in a measurement direction set beforehand. The distance sensor 64 may be a light reflecting type distance sensor including a light source, such as an LED or a laser diode, configured to emit light and a light receiver configured to receive light reflected by the object to be measured, for example. The distance sensor 64 may be an ultrasonic wave type distance sensor including a sound source configured to generate ultrasonic waves, and a detector configured to receive the ultrasonic waves reflected by the object to be measured. The distance sensor 64 may be a laser range scanner (scanning range sensor). This case allows range-scanning to be performed on a wide area including the front area of the image display unit 20.

The controller 10 and the image display unit 20 are coupled via a coupling cable 40. The main body 11 includes a connector 42 to which the coupling cable 40 is detachably coupled.

The coupling cable 40 includes an audio connector 46, where the audio connector 46 is coupled with a headset 30. The headset 30 includes a right earphone 32 and a left earphone 34 constituting a stereo headphone, and a microphone 63.

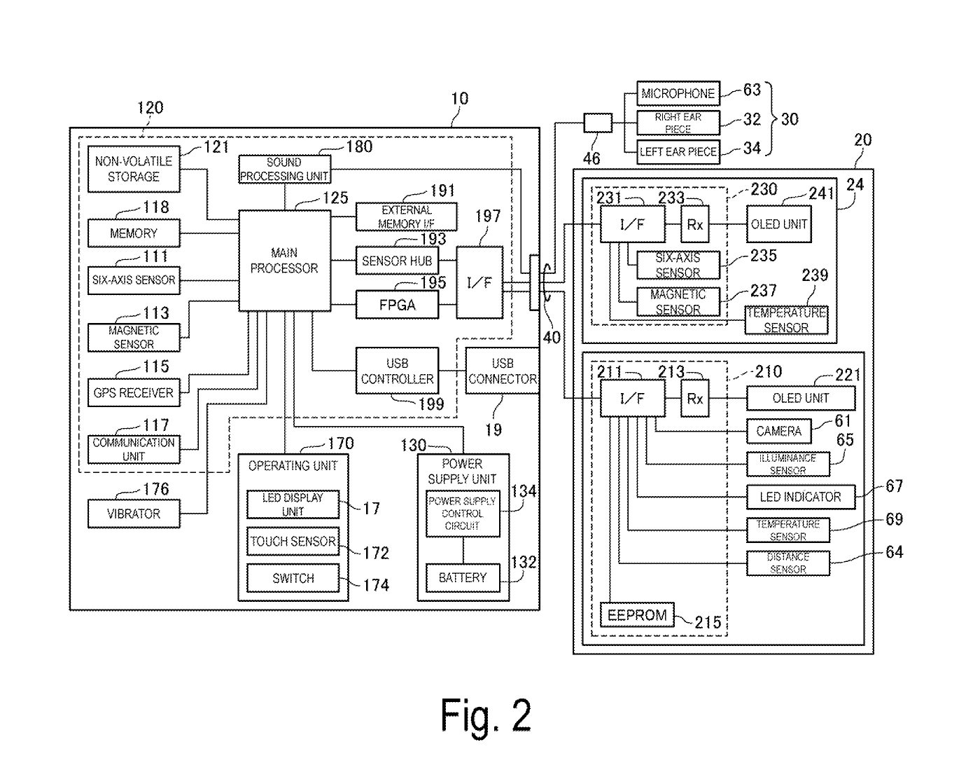

The right earphone 32 is attached to the right ear of the user U, while the left earphone 34 is attached to the left ear of the user U. The microphone 63 is configured to collect sound and to then output a sound signal to a sound processing unit 180 (FIG. 2).

The controller 10 includes, as operation components to be operated by the user U, a wheel operation portion 12, a center key 13, an operation pad 14, an up and down key 15, and a power switch 18. These operation components are arranged on a surface of the main body 11. These operation components are operated, for example, with fingers/hands of the user U.

The operation pad 14 is configured to include an operation face for detecting a touch operation and to output an operation signal in response to an operation performed onto the operation face. The detection type on the operation face may be an electrostatic type, a pressure detection type, and an optical type, without being limited to a specific type. The operation pad 14 outputs to the controller 150 a signal indicative of a position on the operation face at which a touch is detected.

A Light Emitting Diode (LED) display unit 17 is configured to display characters, symbols, patterns, and the like formed in a light transmissive portion by tuning on the LED embedded in the light transmissive portion transmissive of light. The surface on which the display is performed forms an area where a touch operation can be detected with a touch sensor 172 (FIG. 2). Accordingly, the LED display unit 17 and the touch sensor 172 are combined to function as software keys. The power switch 18 is used to turn on or off a power supply to the HMD 100. The main body 11 includes a

Universal Serial Bus (USB) connector 19 as an interface for coupling the controller 10 to external devices.

FIG. 2 is a block diagram illustrating a configuration of components configuring the HMD 100.

The controller 10 includes a main processor 125 configured to execute a program to control the HMD 100. The main processor 125 is coupled with a memory 118 and a non-volatile storage 121. The main processor 125 is coupled with an operating unit 170 serving as an input device. The main processor 125 is further coupled with sensors, such as a six-axis sensor 111, a magnetic sensor 113, and a global positioning system (GPS) 115.

The main processor 125 is coupled with a communication unit 117, the sound processing unit 180, an external memory interface 191, a USB controller 199, a sensor hub 193, and an FPGA 195. These components function as interfaces to external devices.

The main processor 125 is mounted on a controller substrate 120 build into the controller 10. In the exemplary embodiment, the controller substrate 120 is mounted with the six-axis sensor 111, the magnetic sensor 113, the GPS 115, the communication unit 117, the memory 118, the non-volatile storage 121, and the sound processing unit 180, for example. The external memory interface 191, the sensor hub 193, the FPGA 195, and the USB controller 199 may be mounted on the controller substrate 120. The USB connector 19, the connector 42, and an interface 197 may be mounted on the controller substrate 120.

The memory 118 configures a work area used to temporarily store a program to be executed by the main processor 125 and data to be processed by the main processor 125, for example. The non-volatile storage 121 is configured by a flash memory or an embedded Multi Media Card (eMMC). The non-volatile storage 121 is configured to store programs to be executed by the main processor 125 and data to be processed by the main processor 125.

The operating unit 170 includes the LED display unit 17, the touch sensor 172, and a switch 174. The touch sensor 172 is configured to detect a touch operation performed by the user U, to specify the operation position, and to then output operation signals to the main processor 125. The switch 174 is configured to output operation signals to the main processor 125 in response to the operations of the up and down key 15 and the power switch 18. The LED display unit 17 is configured to follow a control by the main processor 125 to turn on or off the LEDs, as well as to cause the LEDs to blink. The operating unit 170, which is configured by, for example, a switch board on which the LED display unit 17, the touch sensor 172, the switch 174, and circuits for controlling these components are mounted, is housed in the main body 11.

The six-axis sensor 111 is an example of a motion sensor (inertial sensor) configured to detect a motion of the controller 10. The six-axis sensor 111 includes a three-axis acceleration sensor configured to detect accelerations in the directions of three axes indicated by X, Y, and Z in FIG. 1 and a three-axis gyro sensor configured to detect angular velocities of the rotations around X, Y, and Z axes. The six-axis sensor 111 may be an Inertial Measurement Unit (IMU) with the sensors, described above, formed into a module. The magnetic sensor 113 is a three-axis geomagnetic sensor, for example.

A Global Positioning System (GPS) 115 is a position detector configured to receive GPS signals transmitted from GPS satellites and then to detect or calculate the coordinates of the current position of the controller 10.

The six-axis sensor 111, the magnetic sensor 113, and the GPS 115 output values to the main processor 125 in accordance with a sampling period specified beforehand. The six-axis sensor 111, the magnetic sensor 113, and the GPS 115 may also output detected values to the main processor 125 at the timings designated by the main processor 125 in response to the requests from the main processor 125.

The communication unit 117 is a communication device configured to execute wireless communications with an external device. The communication unit 117 includes, for example, an antenna, an RF circuit, a baseband circuit, and a communication control circuit (not illustrated), and may be a device or a communication module board formed by being integrated with these components.

The communication schemes of the communication unit 117 include Wi-Fi (trade name), Worldwide Interoperability for Microwave Access (WiMAX; trade name, Bluetooth (trade name), Bluetooth Low Energy (BLE), Digital Enhanced Cordless Telecommunications (DECT), ZigBee (trade name), and Ultra-Wide Band (UWB).

The sound processing unit 180, which is coupled to the audio connector 46, performs input/output of sound signals and encoding/decoding of sound signals. The sound processing unit 180 may include an A/D converter configured to convert analog sound signals into digital sound data, and a D/A converter configured to convert the digital sound data into the analog sound signals.

The external memory interface 191 serves as an interface configured to be coupled with a portable memory device and includes an interface circuit and a memory card slot configured to be attached with a card-type recording medium to read data, for example.

The controller 10 is mounted with a vibrator 176. The vibrator 176 includes, for example, a motor equipped with an eccentric rotor, and generates vibrations under the control of the main processor 125.

The interface (I/F) 197 couples the sensor hub 193 and the Field Programmable Gate Array (FPGA) 195 to the image display unit 20. The sensor hub 193 is configured to acquire detected values of the sensors included in the image display unit 20 and output the detected values to the main processor 125. The FPGA 195 is configured to process data to be transmitted and received between the main processor 125 and components of the image display unit 20, as well as to execute transmissions via the interface 197.

With the coupling cable 40 and wires (not illustrated) inside the image display unit 20, the controller 10 is separately coupled with the right display unit 22 and the left display unit 24.

The right display unit 22 includes an Organic Light Emitting Diode (OLED) unit 221 configured to emit imaging light. The imaging light emitted by the OLED unit 221 is guided to the right light-guiding plate 26 by an optical system including a lens group, for example. The left display unit 24 includes an OLED unit 241 configured to emit imaging light. The imaging light emitted by the OLED unit 241 is guided to the left light-guiding plate 28 by an optical system including a lens group, for example.

The OLED units 221 and 241 each include drive circuits configured to drive an OLED panel. The OLED panel is a light emission type display panel including light-emitting elements arranged in a matrix pattern and configured to emit red (R) color light, green (G) color light, and blue (B) color light, respectively, by means of organic electro-luminescence. The OLED panel includes a plurality of pixels each including an R element, a G element, and a B element arranged in a matrix pattern, and is configured to form an image. The drive circuits are controlled by the controller 150 to select and power the light-emitting elements included in the OLED panel to cause the light-emitting elements included in the OLED panel to emit light. This allows the imaging lights of the image formed on the OLED units 221 and 241 to be guided to the right light-guiding plate 26 and the left light-guiding plate 28, and to be then incident on the right and left eyes of the user U.

The right display unit 22 includes a display unit substrate 210. The display unit substrate 210 is mounted with an interface (I/F) 211 coupled to the interface 197, a receiver (Rx) 213 configured to receive data entered from the controller 10 via the interface 211, and an electrically erasable programmable read only memory (EEPROM) 215. The interface 211 couples the receiver 213, the EEPROM 215, a temperature sensor 69, the camera 61, the illuminance sensor 65, and the LED indicator 67 to the controller 10.

The Electrically Erasable Programmable Read Only Memory (EEPROM) 215 is configured to store data in a manner readable by the main processor 125. The EEPROM 215 stores data about a light-emitting property and a display property of the OLED units 221 and 241 included in the image display unit 20, and data about a property of a sensor included in the right display unit 22 or the left display unit 24, for example. Specifically, the EEPROM 215 stores parameters regarding Gamma correction performed by the OLED units 221 and 241 and data used to compensate for detected values of the temperature sensor 69 and a temperature sensor 239, for example. The data is generated when the HMD 100 is inspected before shipping from a factory, and written into the EEPROM 215. After shipped, the main processor 125 can use the data in the EEPROM 215 for performing processing.

The camera 61 follows a signal entered via the interface 211, executes imaging, and outputs captured image data or a signal indicative of the result of capturing image to the interface 211.

The illuminance sensor 65 is configured to output a detected value corresponding to an amount of received light (intensity of received light) to the interface 211. The LED indicator 67 follows a signal to be entered via the interface 211 to come on or go off.

The temperature sensor 69 is configured to detect the temperatures and to output voltage values or resistance values each corresponding to the detected temperatures to the interface 211 as detected values. The temperature sensor 69 is mounted on a rear face of the OLED panel included in the OLED unit 221 or a substrate mounted with the drive circuits configured to drive the OLED panel to detect a temperature of the OLED panel. In case when the OLED panel is mounted as an Si-OLED together with the drive circuits and the like to form an integrated circuit on an integrated semiconductor chip, the temperature sensor 69 may be mounted on the semiconductor chip.

The receiver 213 is configured to receive data transmitted by the main processor 125 via the interface 211. Upon receiving image data via the interface 211, the receiver 213 outputs the received image data to the OLED unit 221.

The left display unit 24 includes a display unit substrate 230. The display unit substrate 230 is mounted with an interface (I/F) 231 coupled to the interface 197 and a receiver (Rx) 233 configured to receive data entered by the controller 10 via the interface 231. The display unit substrate 230 is further mounted with a six-axis sensor 235 and a magnetic sensor 237. The interface 231 couples the receiver 233, the six-axis sensor 235, the magnetic sensor 237, and the temperature sensor 239 to the controller 10.

The six-axis sensor 235 is an example of a motion sensor configured to detect a motion of the image display unit 20. Specifically, the six-axis sensor 235 includes a three-axis acceleration sensor configured to detect accelerations in the X, Y, and Z axial directions in FIG. 1 and a three-axis gyro sensor configured to detect accelerations of the rotations around the X, Y, and Z axes. The six-axis sensor 235 may be an IMU with the sensors, described above, formed into a module. The magnetic sensor 237 is a three-axis geomagnetic sensor, for example.

The temperature sensor 239 is configured to detect the temperatures and to output voltage values or resistance values each corresponding to the detected temperatures to the interface 231 as detected values. The temperature sensor 239 is mounted on a rear face of the OLED panel included in the OLED unit 241 or a substrate mounted with the drive circuits configured to drive the OLED panel to detect a temperature of the OLED panel. In case when the OLED panel is mounted as an Si-OLED together with the drive circuits and the like to form an integrated circuit on an integrated semiconductor chip, the temperature sensor 239 may be mounted on the semiconductor chip.

The camera 61, the illuminance sensor 65, the temperature sensor 69, the six-axis sensor 235, the magnetic sensor 237, and the temperature sensor 239 are coupled to the sensor hub 193 of the controller 10.

The sensor hub 193 is configured to follow a control by the main processor 125 and set and initialize sampling periods of the sensors. In synchronization with the sampling periods of the sensors, the sensor hub 193 supplies power to the sensors, transmits control data, and acquires detected values, for example. At a timing set beforehand, the sensor hub 193 outputs detected values of the sensors to the main processor 125. The sensor hub 193 may include a function of temporarily holding detected values of the sensors in conformity to a timing of output to the main processor 125. The sensor hub 193 may include a function of converting data in a format into data in a unified data format in response to a difference in signal format of output values of the sensors or in data format, and outputting the converted data to the main processor 125.

The sensor hub 193 follows a control by the main processor 125, turns on or off power to the LED indicator 67, and allows the LED indicator 67 to come on or blink at a timing when the camera 61 starts or ends image capturing.

The controller 10 includes a power supply unit 130 and is configured to operate with power supplied from the power supply unit 130. The power supply unit 130 includes a rechargeable battery 132 and a power supply control circuit 134 configured to detect a remaining amount of the battery 132 and control charging to the battery 132.

The USB controller 199 is configured to function as a USB device controller, establish a communication with a USB host device coupled to the USB connector 19, and perform data communications. In addition to the function of the USB device controller, the USB controller 199 may include a function of a USB host controller.

FIG. 3 is a functional block diagram of a storage 140 and the controller 150 both configuring a control system of the controller 10 of the HMD 100. The storage 140 illustrated in FIG. 3 is a logical storage including the non-volatile storage 121 (FIG. 2) and may include the EEPROM 215. The controller 150 and various functional units included in the controller 150 are achieved when, as the main processor 125 executes a program, software and hardware work each other. The controller 150 and the functional units configuring the controller 150 are achieved with the main processor 125, the memory 118, and the non-volatile storage 121, for example.

The storage 140 is configured to store various programs to be executed by the main processor 125 and data to be processed with the programs. The storage 140 is configured to store an operating system (OS) 141, an application program 142, setting data 143, and content data 144.

The controller 150 is configured to process, by executing the program stored in the storage 140, the data stored in the storage 140 to control the HMD 100.

The operating system 141 represents a basic control program for the HMD 100. The operating system 141 is executed by the main processor 125. The main processor 125, when the power switch of the HMD 100 is turned on by an operation of the power switch 18, loads and executes the operating system 141. As the main processor 125 executes the operating system 141, various functions of the controller 150 are achieved. The functions of the controller 150 include various functions achieved by a basic controller 151, a communication controller 152, an imaging controller 153, a voice analysis unit 154, an image detection unit 155, a motion detection unit 156, an operation detection unit 157, a display controller 158, and an application execution unit 159.

The application program 142 is a program executed by the main processor 125 while the main processor 125 is executing the operating system 141. The application program 142 uses the various functions of the controller 150. In addition to the application program 142, the storage 140 may store a plurality of programs. For example, the application program 142 is a program for achieving functions such as image content playback, voice content playback, games, camera shooting, document creation, web browsing, schedule management, voice communication, image communication, and route navigation.

The setting data 143 includes various set values regarding operation of the HMD 100. The setting data 143 may include parameters, determinants, computing equations, look-up tables (LUTs), and the like used when the controller 150 controls the HMD 100.

The setting data 143 also includes data used when the application program 142 is executed. More specifically, the setting data 143 includes data such as execution conditions for executing various programs included in the application program 142. For example, the setting data 143 includes data indicating, for example, the image display size at the time when the application program 142 is executed, the orientation of the screen, the functional units of the controller 150 used by the application program 142, or the sensors of the HMD 100.

The HMD 100, when the application program 142 is to be installed, executes the installation process with the function of the controller 150. The installation process includes a process of storing the application program 142 in the storage 140, as well as a process of setting execution conditions of the application program 142 and the like. The installation process causes the setting data 143 corresponding to the application program 142 to be generated or stored in the storage 140, then the application execution unit 159 allows the application program 142 to be executed.

The content data 144 is data of contents including images and videos to be displayed by the image display unit 20 under the control of the controller 150. The content data 144 includes still image data, video (moving image) data, sound data, and the like. The content data 144 may include data of a plurality of contents.

Input auxiliary data 145 are data for assisting a data input operation using the HMD 100.

The HMD 100 of the exemplary embodiment has a function of assisting the operation of inputting data by the user U. Specifically, in case when normal data to be entered by the operations of the user U is set beforehand, the HMD 100 provides auxiliary data that are similar to the normal data to the user U. The user U performs an operation of editing the auxiliary data provided by the HMD 100 and processes the auxiliary data into normal data. This allows data to be entered with a simpler operation than with an operation of entering normal data with no assistance.

In the descriptions below, normal data to be entered and the auxiliary data are each made to be a character string. For example, a case is assumed such that the user U inputs a character string to an input box arranged on a web page while using the web browser with the function of the HMD 100.

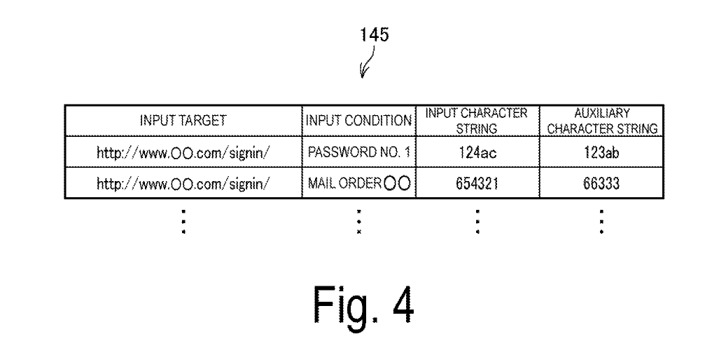

FIG. 4 is a schematic diagram illustrating a configuration example of the input auxiliary data 145.

In this example, the input auxiliary data 145 stores an input target of data, an input character string as input data, and an input condition as a condition for assisting a data input operation in association with one another. The input target is, for example, the Uniform Resource Locator (URL) of a webpage displayed by the web browser function of the HMD 100. The input character string is normal data to be entered in the input area of the webpage. In the exemplary embodiment, the input character string is a password used for authentication to the webpage. The input target is a URL.

The controller 150 is configured to cause, when the input condition is established in case when the web page of the URL set as the input target is displayed, the image display unit 20 to display, as a candidate, an auxiliary character string for facilitating the input character string to be entered. The auxiliary character string is auxiliary data having the same attribute as and a different attribute from the input character string. Herein, the attribute refers to number of characters constituting the character string, the type of character, and the character. The types of characters may be, for example, alphabets, numbers, symbols, hiragana, katakana, or kanji (Chinese characters). The types of characters may include character types that are used in other languages. In addition, uppercase letters and lowercase letters of the alphabet may be handled as different types to each other. The controller 150 may generate an auxiliary character string based on the input character string, while in the exemplary embodiment, the input auxiliary data 145 includes an auxiliary character string in association with the input character string. For example, “123ab” is exemplified an auxiliary character string corresponding to the input character string “124 ac”. The auxiliary character string has number of characters and character type common with and some characters different from the input character string. In the example of FIG. 4, “66333” is included in the input auxiliary data 145 as an auxiliary character string corresponding to the input character string “654321”. The auxiliary character string has character type common with the input character string.

An auxiliary character string has an attribute common with and an attribute different from the input character string to be originally entered. In other words, the auxiliary character string is a character string similar to, but not identical to the input character string. The user U, by viewing the auxiliary character string, can recall the input character string as normal input data and can correctly enter the input character string. Further, using the auxiliary character string allows the confidentiality of the input character string to be maintained.

The input condition, which is a condition set for the operation performed by the user U, is detectable by the HMD 100. The operation of the user U is, specifically, a voice input using the microphone 63, a motion input using the six-axis sensor 235, capturing images of an object or an image code using the camera 61, and the like. In the example of FIG. 4, the input condition is set to an input of the term “Password No. 1” by way of voice. In this case, an establishment of the input condition is determined when the user U pronounces “Password No. 1” in a voice, then the auxiliary character string is displayed.

Tuning back to FIG. 3, voice dictionary data 146 is data for enabling the controller 150 to analyze a voice of the user U collected by the microphone 63. For example, the voice dictionary data 146 includes dictionary data for converting the digital data of the voice of the user U into texts of Japanese, English or other languages that are set.

Image detection data 147 is reference data for enabling the controller 150 to analyze captured image data of the camera 61 to detect an image of a specific subject included in the captured image data. The specific subject may be, for example, an indicator used for gesture operation such as finger, hand, foot, other body parts of the user U, or an indicator for operation.

The HMD 100 allows an input to be performed by a gesture operation of moving the indicator within the image capturing range of the camera 61. The indicator used in the gesture operation is designated beforehand, that is, for example, finger, hand, foot, other body parts of the user U, or an indicator in a rod shape or other shapes. The image detection data 147 includes data for detecting an indicator used in the gesture operation from the captured image data. In this case, the image detection data 147 includes an image characteristic amount for detecting the image of the indicator from the captured image data and data for detecting the image of the indicator by pattern matching.

The HMD 100 allows the operation itself causing the camera 61 to capture an image of a specific subject to be the input operation. Specifically, when the subject registered beforehand is captured by the camera 61, the HMD 100 determines that an input is performed. This subject is referred to as input operation subject. The input operation subject may be an image code such as a QR code (trade name) or a bar code, a certificate such as an ID card or a driver's license, or other images. The input operation subject may also be a character, a number, a geometric pattern, an image, or other figures that makes no sense as a code. The image detection data 147 includes data for detecting the image of the subject registered beforehand as the input operation subject from the captured image data of the camera 61. For example, the image detection data 147 includes an image characteristic amount for detecting the input operation subject from the captured image data and data for detecting the input operation subject by pattern matching.

Motion detection data 148 includes data for detecting the motion of the image display unit 20 as an input operation. For example, the motion detection data 148 include data for determining whether a change in detected values of the six-axis sensor 111 and/or the six-axis sensor 235 corresponds to a predefined pattern. A plurality of motion patterns may be included in the motion detection data 148.

The basic controller 151 executes a basic function for controlling the components of the HMD 100. When the power of the HMD 100 is turned on, the basic controller 151 executes a start-up process and initializes each of the components of the HMD 100, then the application execution unit 159 causes the application program 142 to be in a state of being executable. The basic controller 151 executes a shut-down process of turning off the power supply of the controller 10, terminates the operations of the application execution unit 159, updates various data stored in the storage 140, and causes the HMD 100 to be stopped. In the shut-down process, the power supply to the image display unit 20 also stops, wholly shutting down the HMD 100.

The basic controller 151 has a function of controlling the power supply performed by the power supply unit 130. With the shut-down process, the basic controller 151 separately turns off power supplied from the power supply unit 130 to each of the components of the HMD 100.

The communication controller 152 is configured to control the communication unit 117 to execute data communications with other devices.

For example, the communication controller 152 receives the content data supplied from a non-illustrated image supply device such as a personal computer with the communication unit 117, and causes the received content data to be stored in the storage 140 as the content data 144.

The imaging controller 153 is configured to control the camera 61 to perform capturing an image, to generate captured image data, and to temporarily store the captured image data in the storage 140. In case when the camera 61 is configured as a camera unit including a circuit configured to generate captured image data, the imaging controller 153 is configured to acquire the captured image data from the camera 61 and to temporarily store the captured image data in the storage 140.

The voice analysis unit 154 is configured to analyze the digital data of the voice collected with the microphone 63 and to execute a voice recognition process of converting the digital data into texts by referring to the voice dictionary data 146. The voice analysis unit 154 is configured to determine whether the texts acquired by the voice recognition process corresponds to the input condition set in the input auxiliary data 145.

The image detection unit 155 is configured to analyze the captured image data captured under the control of the imaging controller 153 with reference to the image detection data 147 to detect the image of the indicator or the input operation subject from the captured image data.

The image detection unit 155 is configured to be capable of executing a process of detecting a gesture operation by detecting the image of the indicator from the captured image data. In this process, the image detection unit 155 executes, on the plurality of captured image data over time, a process of specifying the position of the image of the indicator in the captured image data, and then calculates the trajectory of the positions of the indicator.

The image detection unit 155 is configured to determine whether the trajectory of the positions of the indicator corresponds to an input pattern set beforehand. The image detection unit 155 is configured to detect a gesture operation in case when the trajectory of the positions of the indicator corresponds to an input pattern set beforehand.

The image detection unit 155 is also configured to be capable of executing a process of detecting an input operation subject from the captured image data. This process may be executed in parallel with the process of detecting the indicator of the gesture operation. The image detection unit 155 is configured to execute, based on the image detection data 147, a process such as pattern matching of the captured image data, and to determine, upon detecting an image of the input operation subject in the captured image data, that an input is performed. The input thus causing the camera 61 to capture an image of an input operation subject is referred to as capturing image input. The subject used in capturing image input may be, for example, a card such as an ID card, a three-dimensional subject, or an image attached to a surface of a cubic solid.

The motion detection unit 156 is configured to detect an operation based on the detected values of the six-axis sensor 235 and/or the six-axis sensor 111. Specifically, the motion detection unit 156 is configured to detect the motion of the image display unit 20 as an operation. The motion detection unit 156 is configured to determine whether a change in detected values of the six-axis sensor 235 and/or the six-axis sensor 111 corresponds to the predefined pattern included in the motion detection data 148. The motion detection unit 156 is configured to detect an input performed by the motion of the image display unit 20 when the change in detected values corresponds to the predefined pattern in the motion detection data 148. The input thus moving the image display unit 20 to be compatible with a pattern set beforehand is referred to as motion input.

The operation detection unit 157 is configured to detect an operation on the operating unit 170.

The display controller 158 is configured to generate control signals for controlling the right display unit 22 and the left display unit 24, and to control the generation and emission of the imaging light by each of the right display unit 22 and the left display unit 24. For example, the display controller 158 is configured to cause the OLED panel to display an image, and to perform a control of drawing timing of the OLED panel, a control of luminance, and the like. The display controller 158 is configured to control the image display unit 20 to cause an image to be displayed.

The display controller 158 is also configured to execute an image process of generating signals to be transmitted to the right display unit 22 and the left display unit 24. The display controller 158 is configured to generate a vertical synchronization signal, a horizontal synchronization signal, a clock signal, an analog image signal, and the like based on the image data of the image or video to be displayed by the image display unit 20.

The display controller 158 may be configured to perform, as necessary, a resolution conversion process of converting the resolution of the image data into a resolution suitable for the right display unit 22 and the left display unit 24. The display controller 158 may be configured to perform, for example, an image adjustment process of adjusting the luminance and chromaticness of image data, and a 2D/3D conversion process of creating 2D image data from 3D image data or of creating 3D image data from 2D image data. The display controller 158 is configured to generate, when having performed these image processes, signals for displaying images based on the processed image data, and to transmit the signals to the image display unit 20.

The display controller 158 may be configured with a configuration realized by the main processor 125 executing the operating system 141, or with a hardware different from the main processor 125. The hardware may be a Digital Signal Processor (DSP), for example.

The application execution unit 159 corresponds to a function of executing the application program 142 while the main processor 125 is executing the operating system 141. The application execution unit 159 executes the application program 142 to realize various functions of the application program 142. For example, when any one of the content data 144 stored in the storage 140 is selected by an operation of the operating unit 170, the application program 142 for reproducing the content data 144 is executed. This allows the controller 150 to operate as the application execution unit 159 configured to reproduce the content data 144.

The controller 150 is configured to cause the voice analysis unit 154 to detect a voice input. The controller 150 is also configured to cause the image detection unit 155 to detect a gesturing input of moving the indicator within the image capturing range of the camera 61, and to detect a capturing image input of causing the camera 61 to capture an image of a specific subject. The controller 150 is also configured to cause the motion detection unit 156 to detect a motion input of moving the image display unit 20 in a specific pattern.

In other words, the user U can use a voice input, a gesturing input, a capturing image input, and a motion input as the input measures to the HMD 100.

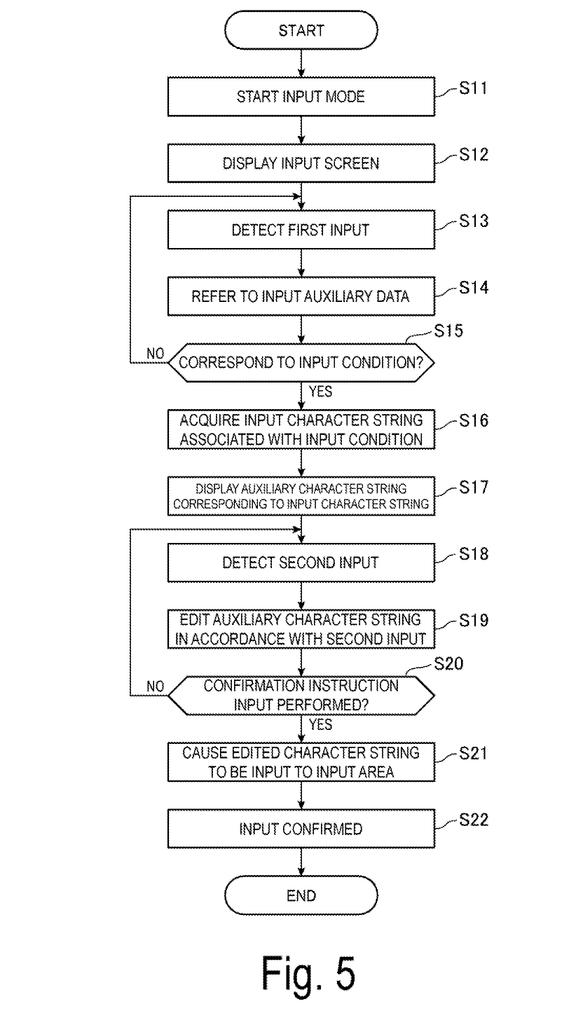

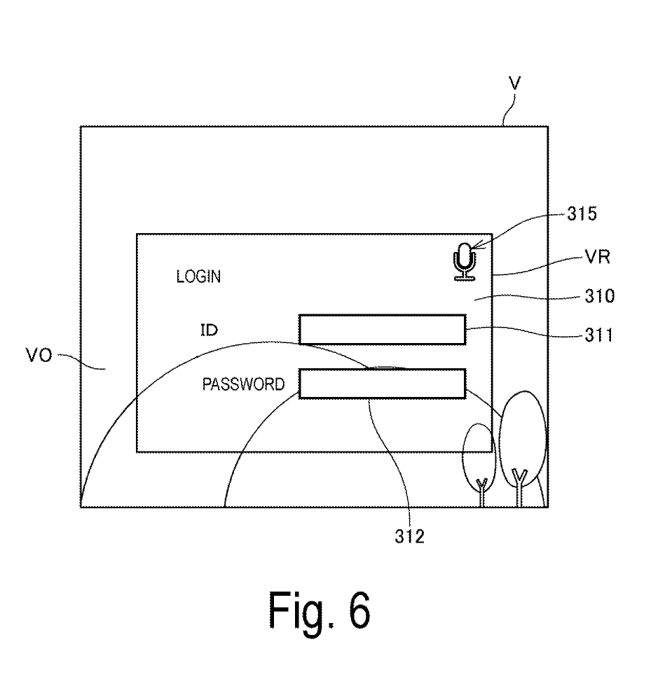

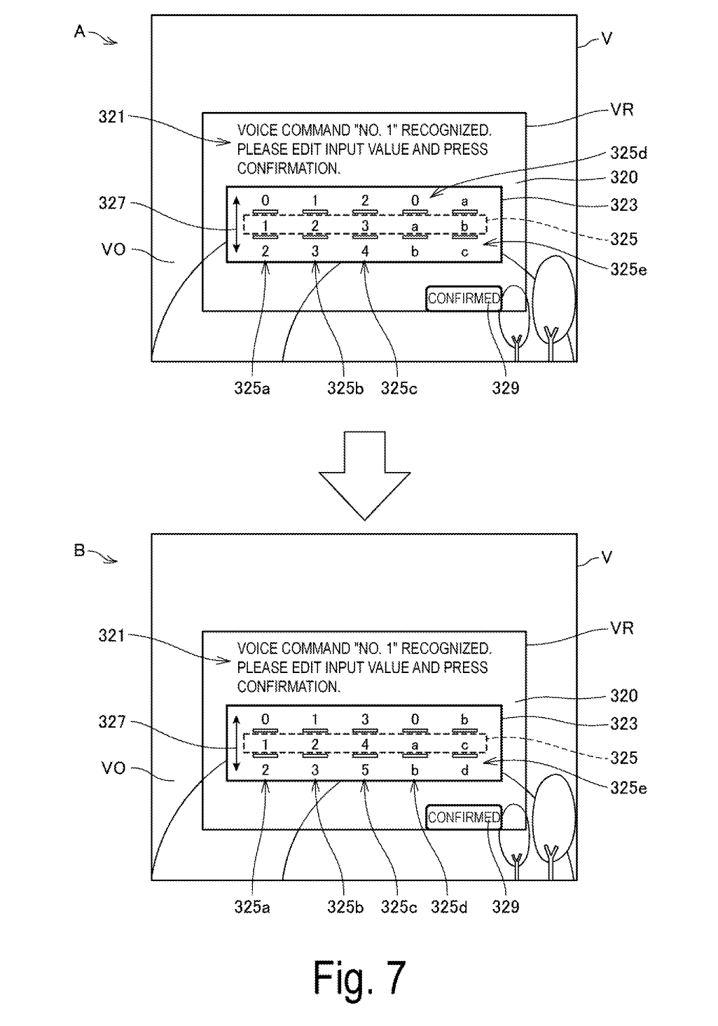

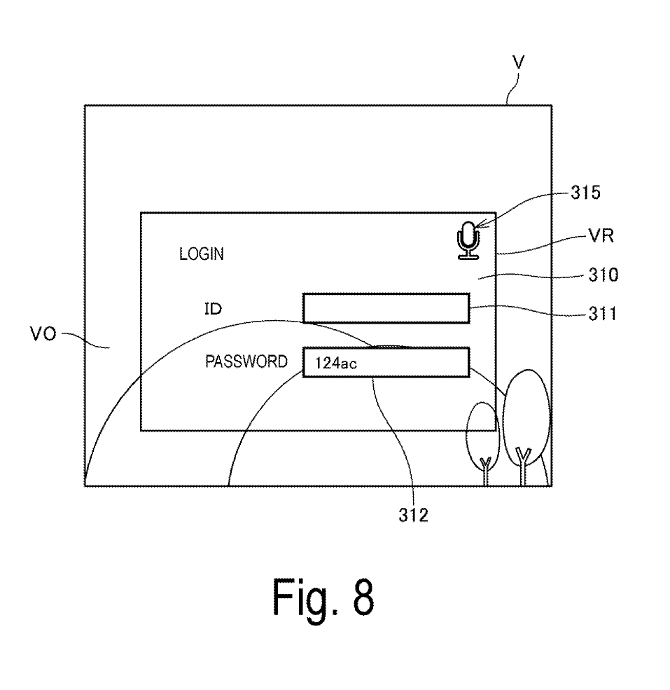

FIG. 5 is a flowchart illustrating operations of the HMD 100. The operation illustrated in FIG. 5 is an operation for assisting the user U to enter a character string while the HMD 100 is displaying a user interface for allowing a character string to be entered. FIG. 6, FIG. 7, and FIG. 8 are diagrams illustrating configuration examples of a screen displayed by the HMD 100, and correspond to an example of a user interface displayed by the operation illustrated in FIG. 5.

The operations of the HMD 100 will be described below based on these drawings. In the operations described below, the controller 150 functions as an input controller.

In each of FIG. 6, FIG. 7 and FIG. 8, the field of view of the user U wearing the image display unit 20 is indicated by the symbol V, the range in which the image displayed by the image display unit 20 is viewed in the field of view V is indicated by VR. Since the symbol VR indicates an area in which the image display unit 20 displays an image, the area is defined as a visualized region VR. In the field of view V, outside view can be viewed in a transmissive manner with external light transmitting through the image display unit 20. The outside view seen in the field of view V is indicated by VO.

The controller 150 starts the input mode (Step S11) in accordance with the operation detected with the function of the operation detection unit 157, and causes the function of the display controller 158 to display the input screen as the input user interface for the input operation on the image display unit 20 (Step S12).

An input screen 310 illustrated in FIG. 6 is an example of a user interface for the input operation. The input screen 310 is, for example, a web page in which a web site is logged in, where input areas 311 and 312 in which a character string is entered, are arranged. The input screen 310 is arranged with a voice icon 315 indicating availability of a voice input.

Tuning back to FIG. 5, the controller 150 detects a first input performed by the user U (Step S13). The controller 150 refers to the input auxiliary data 145 (Step S14), and determines whether the first input detected in Step S13 corresponds to the input condition (Step S15).

The first input may be either one of a voice input, a gesturing input, a capturing image input, and a motion input. Although the input auxiliary data 145 exemplified in FIG. 4 includes an input condition in case when the first input is a voice input, the input auxiliary data 145 may also include input conditions corresponding to the gesturing input, the capturing image input, or the motion input. In case when the first input is a voice input, the voice analysis unit 154 executes Steps S13 to S15. In case when the first input is a gesturing input or a capturing image input, the image detection unit 155 executes Steps S13 to S15. In case when the first input is the motion input, the motion detection unit 156 executes Steps S13 to S15.

When the first input detected in Step S13 does not correspond to the input condition (Step S15; NO), the controller 150 returns to Step S13.

When the first input detected in Step S13 corresponds to the input condition (Step S15; YES), the controller 150 acquires the input character string set in the input auxiliary data 145 in association with the input condition (Step S16).

The controller 150 causes the image display unit 20 to display an auxiliary character string corresponding to the input character string acquired in Step S16 with the function of the display controller 158 (Step S17).

In Step S17, the controller 150 may cause an auxiliary character string set in the input auxiliary data 145 to be displayed in association with the input character string acquired in Step S16. The controller 150 may also cause an auxiliary character string corresponding to the input character string acquired in Step S16 to be generated in accordance with an algorithm set beforehand and may cause the image display unit 20 to display the auxiliary character string.

Herein, the controller 150 detects a second input performed by the user U (Step S18). In accordance with the second input, the controller 150 causes the auxiliary character string displayed in Step S17 to be edited (Step S19). The second input may be either one of a voice input, a gesturing input, a capturing image input, and a motion input.

FIG. 7 illustrates an input screen 320 as an example of a screen displayed by the HMD 100, where the sign A indicates an example in which an auxiliary character string is displayed, and the sign B indicates an example in which an auxiliary character string is edited.

The input screen 320 includes a guidance message 321 for instructing an edition of a character string entered in the input area 312 (FIG. 6) and an editing area 323 for causing a character string to be edited. When the voice input detected by the voice analysis unit 154 corresponds to the input condition, the input screen 320 is displayed in Step S17.

In the editing area 323, “123 ab” as an auxiliary character string is displayed. Each of the digits of the auxiliary character string forms a drum roll type input part capable of selecting a character, and the input screen 320 illustrated in FIG. 7 includes drum input parts 325a, 325b, 325c, 325d, and 325e. An array 325 constituted by characters located at the center of each of the drum input parts 325a, 325b, 325c, 325d, and 325e constitutes an auxiliary character string in the state indicated by the sign A in FIG. 7. The controller 150 is configured to cause, in accordance with the second input performed by the user U, the characters on the drum input parts 325a, 325b, 325c, 325d, and 325e to be changed and to cause the character string of the array 325 to be edited.

Since number of characters of the auxiliary character string is common with the input character string to be originally entered in the input area 312, the user U may select an appropriate character on each of the drum input parts 325a, 325b, 325c, 325d, and 325e. In other words, the input screen 320 stands for assisting the user U in that the user U need not recall the number of characters of the character string to be entered.

The operations of moving the characters on the drum input parts 325a, 325b, 325c, 325d, and 325e are performed in response to the second input. This operation is, for example, a voice input of uttering a character to be selected in the order from the drum input part 325a. This operation may also be, for example, a gesturing input of indicating a specific character, a capturing image input of causing an image of an input operation subject on which a specific character is drawn to be captured, and a motion input of designating a motion direction and a motion amount of an arrow 327.

The sign B in FIG. 7 indicates the input screen 320 having been edited. Changing the characters on the drum input parts 325a, 325b, 325c, 325d, and 325e in accordance with the second input caused the character string of the array 325 to be changed to “124ab”.

The input screen 320 is arranged with a confirmation instruction button 329. The confirmation instruction button 329 serves as an operation part to be operated by the user U in case when the array 325 coincides with a character string desired by the user U. When the confirmation instruction button 329 is operated, the controller 150 causes the character string of the array 325 to be confirmed as a character string entered in the input area 312 (FIG. 2).

In Step S19 in FIG. 5, the controller 150 causes the auxiliary character string to be edited in accordance with the second input and determines whether a confirmation instruction input has been performed (Step S20). For example, the confirmation instruction input is an operation of selecting the confirmation instruction button 329. The operation of selecting the confirmation instruction button 329 may also be a voice input of instructing a selection of the confirmation instruction button 329 by way of voice. The operation of selecting the confirmation instruction button 329 may further be, for example, a gesturing input of designating the confirmation instruction button 329, a capturing image input of causing an image of an input operation subject corresponding to the confirmation instruction button 329 to be captured, or a motion input of designating the confirmation instruction button 329.

When the confirmation instruction input has not been performed (Step S20; NO), the controller 150 returns to Step S18 to detect a second input to be further performed. While when the confirmation instruction input has been performed (Step S20; YES), the controller 150 causes the character string of the array 325 to be input to the input area 312 (Step S21). This allows the input character string to the input screen 310 to be confirmed (Step S22).

FIG. 8 illustrates a state where a character string is entered in the input area 312 on the input screen 310. When the confirmation instruction button 329 is selected on the input screen 320 (FIG. 7), the character string having been edited on the input screen 320 is caused to be input to the input area 312 as illustrated in FIG. 8. An operation of thus editing the auxiliary character string on the input screen 320 is performed to cause a character string to be input to the input area 312.

In the above example, although each of the characters constituting the auxiliary character string is edited one by one with the drum input parts 325a, 325b, 325c, 325d, and 325e, a configuration of editing the auxiliary character string by another operation may also be employed.

For example, an interchange box for interchanging the arrangement order of characters may be displayed as a user interface for the edition of the auxiliary character string. In this case, the auxiliary character string is a character string in which the characters constituting the input character string as normal data are arranged in a different order from normal data, where normal data can be created by interchanging the order of the characters of the auxiliary character string. The interchange box is an interface capable of interchanging the arrangement order of characters by a voice input or a gesturing input. In this case, interchanging characters allows an input character string to be entered, maintaining the confidentiality of the input character string and facilitating the input operation.

For example, a configuration may also be employed in which the auxiliary character string is edited by interchanging the characters of the auxiliary character string based on the gesturing input to a software keyboard displayed together with an auxiliary character string by the image display unit 20. The auxiliary character string may also be edited in accordance with a voice input.

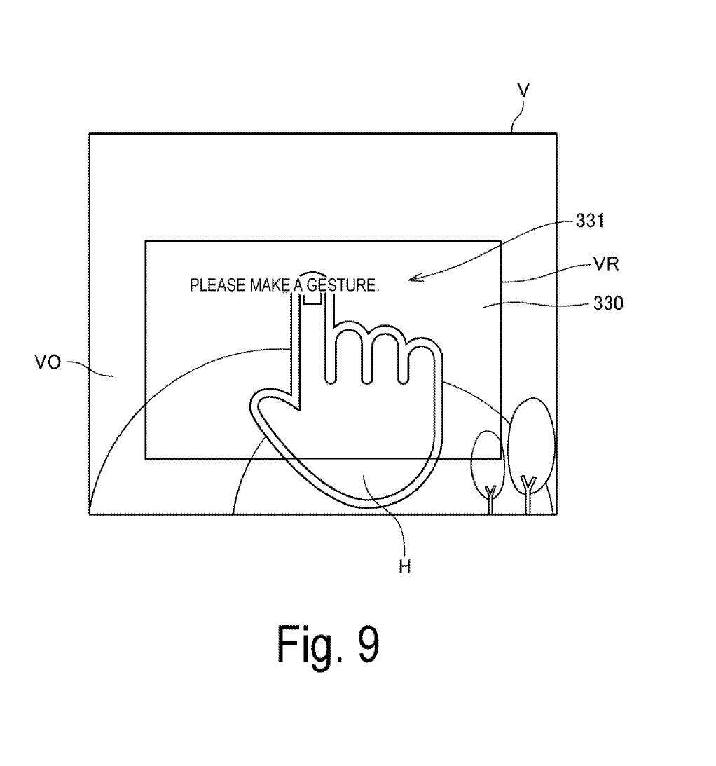

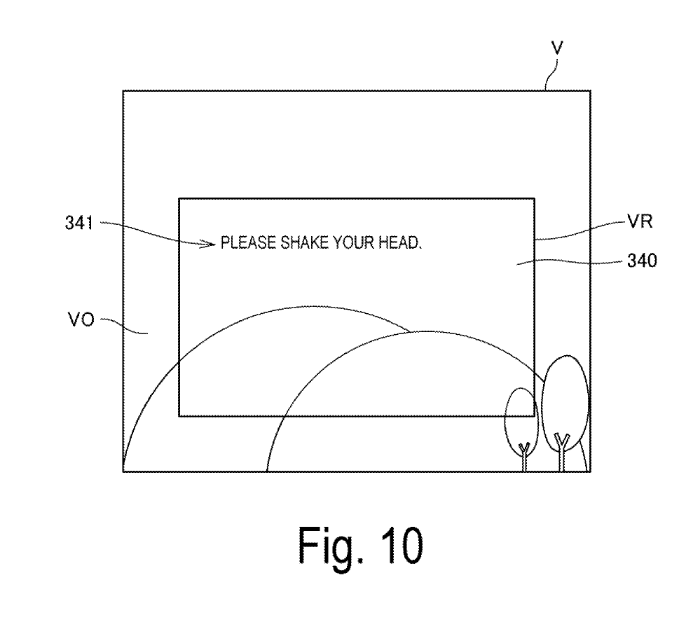

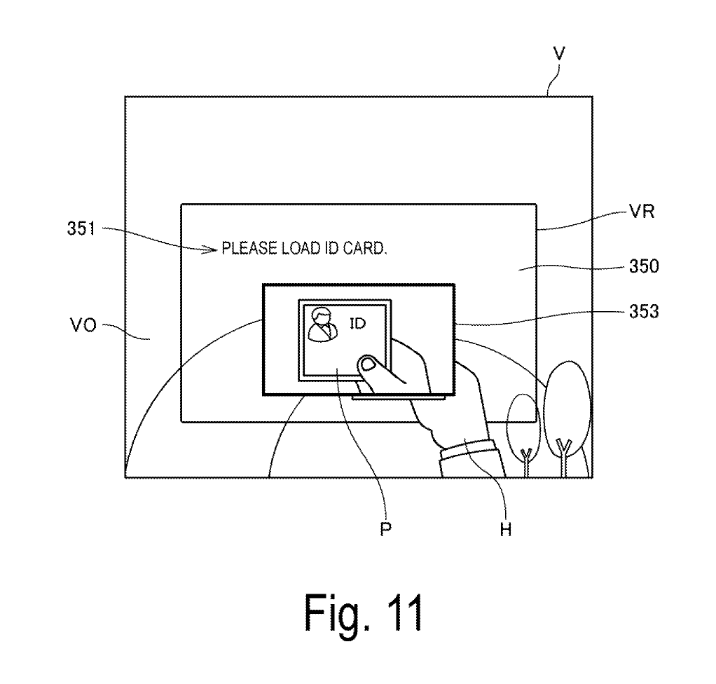

In the above example, although the confirmation instruction operation is to be performed with the confirmation instruction button 329, the confirmation instruction operation may also be performed by other types of operations. These examples are illustrated in FIG. 9, FIG. 10, and FIG. 11.

The visual field V, the visualized region VR, and the outside view VO in FIG. 9, FIG. 10, and FIG. 11 are the same as in FIG. 6.

On a gesturing input screen 330 illustrated in FIG. 9 is displayed a guidance message 331. The guidance message 331 gives the user U a guidance to perform a gesturing input as a confirmation instruction operation.

In the example of FIG. 9, the user U performs, according to the guidance message 331, a gesturing input of moving the hand H within the capturing image range of the camera 61, where in case when the gesturing input corresponds to a condition set beforehand, the confirmation instruction input is detected.

On a motion input screen 340 illustrated in FIG. 10 is displayed a guidance message 341. The guidance message 341 gives the user U a guidance to perform the motion input by the motion of the image display unit 20 as the confirmation instruction operation.

In the example of FIG. 10, the user U moves, according to the guidance message 341, the head on which the image display unit 20 is mounted, where in case when this motion input corresponds to a condition set beforehand, the confirmation instruction input is detected.

On an image input screen 350 illustrated in FIG. 11 is displayed a guidance message 351. The guidance message 351 gives the user U a guidance to capture an image of an ID card with the camera 61 as a confirmation instruction input.

On the image input screen 350, an image capturing frame 353 is displayed as an indication for causing the user U to capture an image of the subject. The image capturing frame 353 is displayed in the visualized region VR of the image display unit 20 to be overlapped with the center of the image capturing range of the camera 61.

The user U performs an operation of superposing an ID card or the like set beforehand as a specific subject on the image capturing frame 353, where in this state the image detection unit 155 detects the subject from the captured image data captured by the camera 61. In the example of FIG. 11, the user U is performing an operation of superimposing an ID card on the image frame 353 with a hand H. When the image detection unit 155 detects the image P of the ID card from the captured image data, a confirmation instruction input is detected.

As described above, the HMD 100 includes the image display unit 20 to be mounted on the head of the user U. The HMD 100 includes a first input portion configured to receive an input performed by the user U and a second input portion configured to receive an input performed by the user U in a different manner from the first input portion. The HMD 100 includes the controller 150 configured to perform an input mode in which the image display unit 20 is caused to display a user interface for character input and to then allow a character or a character string to be entered. The controller 150 is configured to cause auxiliary data to be arranged and to be then displayed on the user interface in response to the input received at the first input portion, and to cause the auxiliary data to be edited in response to the input received at the second input portion to cause the edited data to be input to the user interface. The auxiliary data includes a first attribute and a second attribute, where the first attribute is common with normal data to be entered in the user interface, and the second attribute is data that is different from normal data.

The HMD 100 includes the voice analysis unit 154, the image detection unit 155, and the motion detection unit 156, where one selected from these components functions as the first input portion, while one of the other components functions as the second input portion. The first input portion and the second input portion can be combined without limitation. Since the image detection unit 155 functions as a different input unit in case when detecting a gesturing input than in case when detecting a capturing image input, the image detection unit 155 may function as a first input portion as well as a second input portion.

According to the HMD 100 to which the head-mounted display apparatus and the method for controlling the head-mounted display apparatus according to the invention is applied, in case when a character string is to be entered in the user interface, auxiliary data having an attribute common with and an attribute different from the character string to be entered is displayed. The user U is allowed, by editing the auxiliary data, to enter a normal character or a normal character string. This allows the confidentiality of a normal character or a normal character string to be maintained, alleviating the burden of the input operations. Furthermore, auxiliary data different from a normal character or a normal character string are displayed on the image display unit 20 to be mounted on the head of the user U, enabling the confidentiality of the input data to be more reliably maintained.

The auxiliary data and the normal data are each constituted by a character string, where the auxiliary data is an auxiliary character string, and the normal data is an input character string. The first attribute is number of characters, and the second attribute is any one or more of characters. This allows the auxiliary character string having number of characters common with and any one or more characters different from the normal character string to be entered to be displayed, alleviating the burden of input operations of entering a character or a character string in the user interface.

The HMD 100 is configured to cause normal data to be stored in the storage 140 in association with the input received at the first input portion. The controller 150 may be configured to cause auxiliary data to be generated based on the normal data stored in the storage 140 in association with the input received at the first input portion, and to then cause the auxiliary data to be arranged and to be displayed on the user interface. This case allows auxiliary data to be displayed on the user interface corresponding to a normal character or a normal character string to be generated, eliminating the need of storing auxiliary data beforehand, to thus cause the processing to be performed in an efficient manner.

The HMD 100 may also be configured to cause the normal data, the auxiliary data, and the input received at the first input portion to be stored in the storage 140 in association with one another as the input auxiliary data 145. The controller 150 is configured to cause the auxiliary data stored in the storage 140 in association with the input received at the first input portion to be arranged and to be then displayed on the user interface. This allows the auxiliary data displayed on the user interface to be stored in association with the operations of the user U, enabling appropriate auxiliary data corresponding to the operations of the user U to be displayed. This further allows the user U to readily recognize the auxiliary data displayed corresponding to the operation, alleviating the burden of an operation of editing the auxiliary data in an efficient manner.

The user interface includes a plurality of input areas where data input is required, and the controller 150 is configured to cause the auxiliary data to be arranged and to be then displayed in any one of the input areas. For example, the input screen 310 as the user interface includes the input area 311 and the input area 312, where the controller 150 is configured to cause auxiliary data entered in the input area 312 to be displayed on the input screen 320. This allows, by a method of causing auxiliary data to be edited, a character or a character string to be readily input to a part of an input area arranged in the user interface. For example, the input area using the auxiliary data is limited to a part of the input area to which highly confidential information is input, allowing the operations of the user U to be efficiently assisted.

The controller 150 is configured to cause, in case when causing the auxiliary data to be edited in response to the input received at the second input portion and then receiving a confirmation instruction input at the first input portion or the second input portion, the edited data to be input. This allows the operator to instruct whether to confirm the data edited from the auxiliary data, to thus prevent an erroneous input from being performed.

The HMD 100 includes a third input portion. As in the first input portion and the second input portion, the third input portion is one selected from the voice analysis unit 154, the image detection unit 155, and the motion detection unit 156. The image detection unit 155 functions as a different input unit in case when detecting a gesturing input than in case when detecting a capturing image input. The third input portion may be the first input portion or the second input portion.

The controller 150 is configured to cause, in case when causing the auxiliary data to be edited in response to the input received at the second portion and then receiving a confirmation instruction input at the third input portion, the edited data to be input. This allows the operator to instruct whether to confirm the data edited from the auxiliary data with an operation different from the operations detected by the first input portion and the second input portion, to thus prevent an erroneous input from being performed.

Using the voice analysis unit 154 as the first input portion or the second input portion allows operations related to displaying auxiliary data or editing auxiliary data to be performed by way of voice, alleviating the burden of an operation related to the input operation of a character or a character string in more efficient manner.

The HMD 100 may include the camera 61, and may be configured to cause the image detection unit 155 configured to detect an input of at least one of a position and a motion of an indicator from an image captured by the camera 61 to function as the first input portion or the second input portion. This case allows operations related to displaying auxiliary data or editing auxiliary data to be performed by using the position and/or motion of the indicator, alleviating the burden of an operation related to the input operation of a character or a character string in more efficient manner.

The HMD 100 may be configured to cause the image detection unit 155 configured to detect a code imaged from an image captured by the camera 61 to function as the first input portion or the second input portion. This case allows operations related to displaying auxiliary data or editing auxiliary data to be performed by causing an image of the imaged code to be captured, alleviating the burden of an operation related to the input operation of a character or a character string in more efficient manner.

The HMD 100 may be configured to cause the image detection unit 155 configured to detect, as an input, an image of a subject included in an image captured by the camera 61 to function as the first input portion or the second input portion. This case allows operations related to displaying auxiliary data or editing auxiliary data to be performed by causing an image of the subject to be captured, alleviating the burden of an operation related to the input operation of a character or a character string in more efficient manner.

The invention is not necessarily limited to the above exemplary embodiments, and is carried out in various modes without departing from the gist of the invention.

For example, instead of the image display unit 20, an image display unit of another type such as an image display unit wearable like a cap may be employed, where the image display unit is required to include a display unit configured to display an image corresponding to the left eye of the user U and a display unit configured to display an image corresponding to the right eye of the user U. The display apparatus of the invention may be configured as a head-mounted display to be installed in vehicles such as an automobile and an aircraft. For example, the display apparatus may be configured as a head-mounted display built into a body protector tool such as a helmet. In this case, the head-mounted display may be mounted at a portion determining the position of the portion relative to the body of the user U, and at a portion the position of which is determined relative to the portion.

A configuration may also be employed in which the controller 10 and the image display unit 20 are integrally configured with each other, and are to be mounted on the head of the user U. As the controller 10, a notebook computer, a tablet computer, a desktop computer, portable electronic devices including a game machine, a mobile phone, a smart phone, or a portable media player, and other dedicated devices may be used.

In the above-described embodiment, a description has been made of an exemplary configuration in which the controller 10 and the image display unit 20 are separated from each other and are coupled to each other via the coupling cable 40. The controller 10 and the image display unit 20 may also be coupled to each other via a wireless communication line.

As an optical system guiding imaging light to the eyes of the user U, a system may be employed in which the right light-guiding plate 26 and the left light-guiding plate 28 are configured using a half mirror, a diffraction grating, a prism, or the like. The image display unit 20 may be configured using a holographic display unit.

At least some of the respective functional blocks illustrated in the block diagrams may be configured by hardware, or may be configured through cooperation between hardware and software, without being limited to the configuration in which separate hardware resources are disposed as illustrated in the drawings. A program to be executed by the controller 150 may be stored in the non-volatile storage 121 or other storage devices (not illustrated) in the controller 10. Alternatively, a configuration may be employed in which a program stored in an external device is acquired via the USB connector 19, the communication unit 117, the external memory interface 191, or the like to be executed. The constituent elements provided in the controller 10 may also be provided in the image display unit 20. For example, a processor having an equivalent configuration as the main processor 125 may be disposed in the image display unit 20, and a configuration may be employed in which the main processor 125 of the controller 10 and the processor of the image display unit 20 may each perform individual functions.

In case where the method for controlling the head-mounted display apparatus of the disclosure is realized using a computer, the disclosure may be configured in the mode of a program causing the computer to perform the control method described above, or a recording medium on which the program is recorded in a readable manner by the computer, or a transmission medium for transmitting the program. The recording medium described above may be a magnetic recording medium, an optical recording medium, or a semiconductor memory device. Specifically, a portable or stationary type recording medium, such as a flexible disk, a Hard disk Drive (HDD), a Compact Disk Read Only Memory (CD-ROM), a Digital Versatile Disk (DVD), a Blu-ray (trade name) disc, a magneto-optical disc, a flash memory, a card type recording medium, or the like may be exemplified. The recording medium described above may be non-volatile storage devices such as a Random-Access Memory (RAM), a Read Only Memory (ROM), and a Hard Disk Drive (HDD), all representing internal storages included in an image display apparatus.

The entire disclosure of Japanese Patent Application No. 2018-030857, filed Feb. 23, 2018 is expressly incorporated by reference herein.

What is claimed is:

1. A head-mounted display apparatus comprising:
a display unit to be mounted on a head of a user;
a first input portion configured to receive an input by the user;
a second input portion configured to receive an input by the user in a different manner from the input to the first input portion; and
an input controller configured to perform an input mode in which the display unit is caused to display a user interface for character input and to then cause a character or a character string to be entered, wherein
the controller is configured to cause, in the input mode, auxiliary data to be arranged and to be then displayed on the user interface in response to the input received at the first input portion, and
to then cause the auxiliary data to be edited in response to the input received at the second input portion to cause the edited data to be input in the user interface, and wherein
the auxiliary data includes a first attribute and a second attribute, the first attribute being common with normal data to be entered in the user interface, and the second attribute being data that is different from the normal data.

2. The head-mounted display apparatus according to claim 1, wherein
the auxiliary data and the normal data are each constituted by a character string, wherein the first attribute is number of characters, and the second attribute is any one character or more of characters.

3. The head-mounted display apparatus according to claim 1, including a storage configured to store the normal data in association with an input received at the first input portion, wherein
the input controller is configured to cause the auxiliary data to be generated based on the normal data stored in the storage in association with the input received at the first input portion, and to then cause the auxiliary data to be arranged and to be then displayed on the user interface.

4. The head-mounted display apparatus according to claim 1, comprising
a storage configured to store the normal data, the auxiliary data, and the input received at the first input portion in association with one another, wherein
the input controller is configured to cause the auxiliary data stored in the storage in association with the input received at the first input portion to be arranged and to be then displayed on the user interface.

5. The head-mounted display apparatus according to claim 1, wherein
the user interface includes a plurality of input areas where data input is required, and
the controller is configured to cause the auxiliary data to be arranged and to be then displayed in any one of the input areas.

6. The head-mounted display apparatus according to claim 1, wherein
the input controller is configured to cause, in case when causing the auxiliary data to be edited in response to the input received at the second input portion and then receiving an input at the first input portion or the second input portion, the edited data to be input.

7. The head-mounted display apparatus according to claim 1, including a third input portion, wherein
the controller is configured to cause, in case when causing the auxiliary data to be edited in response to the input received at the second portion and then receiving an input at the third input portion, the edited data to be input.

8. The head-mounted display apparatus according to claim 1, wherein
the first input portion or the second input portion is configured to detect a sound input.

9. The head-mounted display apparatus according to claim 1, including an image capturing unit, wherein
the first input portion or the second input portion is configured to detect an input of at least one of a position and a motion of an indicator from an image captured by the image capturing unit.

10. The head-mounted display apparatus according to claim 1, including an image capturing unit, wherein
the first input portion or the second input portion is configured to detect a code imaged from an image captured by the image capturing unit.

11. The head-mounted display apparatus according to claim 1, including an image capturing unit, wherein
the first input portion or the second input portion is configured to detect, as an input, an image of a subject included in an image captured by the image capturing unit.

12. A method for controlling a head-mounted display apparatus including a display unit to be mounted on a head of a user,
the method being capable of performing an input mode in which the display unit causes a user interface for character input to be displayed to cause a character or a character string to be entered in the user interface, the method comprising:
causing a first input by the user and a second input in a different manner from the first input to be received;
and in the input mode,
displaying auxiliary data having a first attribute and a second attribute, the first attribute being common with normal data to be entered in the user interface and the second attribute being different from the normal data, on the user interface in response to the first input, and
causing the auxiliary data to be edited in response to the second input to cause the edited data to be input to the user interface.
